(19) United States
(12) Patent Application Publication
(10) Pub. No.: US 2023/0279237 A1
(43) Pub. Date: Sep. 7, 2023

(54) SINTER POWDER (SP) CONTAINING A THERMOPLASTIC POLYURETHANE, A PLASTICIZER AND AN ORGANIC ADDITIVE

(71) Applicant: BASF SE, Ludwigshafen am Rhein (DE)

(72) Inventors: Leander VERBELEN, Heidelberg (DE); Rajan HOLIMANN, Lemfoerde (DE); Jean ROCHETTE, Frontonas (FR); Frank SCHAEFER, Lemfoerde (DE); Viktor FISCHER, Heidelberg (DE); Andre METZGER, Heidelberg (DE); Sinan KURT, Heidelberg (DE)

(21) Appl. No.: 18/019,254

(22) PCT Filed: Jul. 27, 2021
(86) PCT No.: PCT/EP2021/071052

§ 371 Date: Feb. 2, 2023

(30) Foreign Application Priority Data
Aug. 3, 2020 (EP) 20189239.5

(51) Int. Cl. C09D 5/03; C09D 7/61; C09D 7/63; C09D 7/80; C09D 175/04

(52) U.S. Cl. CPC C09D 5/037; C09D 5/031; C09D 7/61; C09D 7/63; C09D 7/80; C09D 175/04; C08K 13/04

(57) ABSTRACT

The present invention relates to a sinter powder (SP) comprising 59.5% to 99.85% by weight of at least one thermoplastic polyurethane (A), 0.05% to 0.5% by weight of at least one flow agent (B), 0.1% to 5% by weight of at least one organic additive (C), 0% to 5% by weight of at least one further additive (D) and 0% to 30% by weight of at least one reinforcer (E), based in each case on the sum total of the percentages by weight (A), (B), (C), (D) and (E). The present invention further relates to a method of producing a shaped body by sintering the sinter powder (SP), to a shaped body obtainable by the method of the invention, and to the use of at least one flow agent (B) and at least one organic additive (C) in a sinter powder (SP) to improve the flowability and coalescence of the sinter powder (SP). The present invention further relates to the use of the sinter powder (SP) in a sintering method, and to a method of producing the sinter powder (SP).

The present invention relates to a sinter powder (SP) comprising 59.5% to 99.85% by weight of at least one thermoplastic polyurethane (A), 0.05% to 0.5% by weight of at least one flow agent (B), 0.1% to 5% by weight of at least one organic additive (C), 0% to 5% by weight of at least one further additive (D) and 0% to 30% by weight of at least one reinforcer (E), based in each case on the sum total of the percentages by weight (A), (B), (C), (D) and (E). The present invention further relates to a method of producing a shaped body by sintering the sinter powder (SP), to a shaped body obtainable by the method of the invention, and to the use of at least one flow agent (B) and at least one organic additive (C) in a sinter powder (SP) to improve the flowability and coalescence of the sinter powder (SP). The present invention further relates to the use of the sinter powder (SP) in a sintering method, and to a method of producing the sinter powder (SP).

The rapid provision of prototypes is a problem often addressed in recent times. One method which is particularly suitable for this “rapid prototyping” is selective laser sintering (SLS). This involves selectively exposing a plastic powder in a chamber to a laser beam. The powder melts; the molten particles coalesce and resolidify. Repeated application of plastic powder and subsequent exposure to a laser allows modeling of three-dimensional shaped bodies.

The method of selective laser sintering for producing shaped bodies from pulverulent polymers is described in detail in patent specifications U.S. Pat. No. 6,136,948 and WO 96/06881.

A further development of selective laser sintering is high-speed sintering (HSS), described in EP 1 648 686, or what is called multijet fusion technology (MJF) from HP. In high-speed sintering, by spray application of an infrared-absorbing ink onto the component cross section to be sintered, followed by exposure with an infrared source, a higher processing speed is achieved compared to selective laser sintering.

A further variant of sintering is the selective heat sintering (SHS) method that uses the 35 print unit of a conventional thermal printer to selectively melt the plastic powder.

Of particular significance in the abovementioned sintering methods is the flowability of the plastic powder. This should be at a maximum in order for the plastic powder to have good processibility. This is because high flowability firstly enables faultless formation of the powder layers and secondly improves the sintering characteristics of the plastic powder, which affords a shaped body having high quality, i.e. good surface characteristics and high component density.

By contrast, plastic powders having low flowability in sintering methods have poor processibility, and shaped bodies produced therewith often show defects and also have lower component density, which is frequently reflected in the mechanical properties. In addition, poor flowability can lead to problems in powder dosage, and in the worst case to termination of the printing process. As described in the article “An experimental study into the effects of bulk and flow behaviour of laser sintering polymer powders on resulting part properties” by S. Ziegelmeier et al. (Journal of Materials Processing Technology, 2015, 215, 239), plastic powders made of elastic or soft materials in particular, for example thermoplastic polyurethane (TPU), have reduced flowability.

In order to improve flowability, therefore, what are called flow agents, which are also referred to as flow aids, are typically used. The flow agents are generally inorganic additives, for example silicates, metal oxides and minerals.

U.S. Pat. No. 6,110,411 describes, for example, a sinter powder comprising a polyether ester elastomer and 0.02% to 5% by weight, based on the total weight of the sinter powder, of a flow agent. The flow agent used is, for example, fumed silica.

US 2004/0204531 describes a composition comprising 88% to 99.99% by weight of a polymer selected from the group of polyamides, derivatives of polyamides and mixtures thereof, and 0.05% to 0.25% by weight of a flow aid. The flow aid is selected from inorganic pigments and silicas.

A disadvantage, however, is that the use of these flow agents is limited, since, as described, for example, in the article “Laser sintering of polyamides and other polymers” by R. D. Goodridge et al. (Progress in Materials Science, 2012, 57, 229), too high a content of flow agents leads to worsened mechanical properties of the printed shaped bodies. This is particularly because the fusion of the plastic powder during the sintering process is prevented in the case of high contents of inorganic additives. Moreover, the inorganic additives can act as nucleation seeds and accelerate crystallization, which can cause problems such as curling and warpage, for example, in the sintering process.

As well as flowability, the coalescence of the plastic powder in the melting operation also has a major influence on the processibility and especially the mechanical properties of the shaped body produced. It is possible here for plastic powders, for example elastic plastic powders such as TPU that have poor coalescence characteristics, in spite of excellent flowability, to show poor processibility that leads to porous shaped bodies having poor mechanical properties. The occurrence of surface defects and cracks is particularly marked in the case of production of shaped bodies having a complex structure or geometry.

It is thus an object of the present invention to provide a sinter powder which, in a method of producing shaped bodies by sintering, has the aforementioned disadvantages of the sinter powders and methods described in the prior art only to a small degree, if at all. The sinter powder and the method should respectively be producible and performable in a very simple and inexpensive manner.

This object is achieved by a sinter powder (SP) comprising the following components:
59.5% to 99.85% by weight, based on the sum total of the percentages by weight of (A), (B), (C), (D) and (E), of at least one thermoplastic polyurethane (A),
0.05% to 0.5% by weight, based on the sum total of the percentages by weight of (A), (B), (C), (D) and (E), of at least one flow agent (B),
0.1% to 5% by weight, based on the sum total of the percentages by weight of (A), (B), (C), (D) and (E), of at least one organic additive (C),
0% to 5% by weight, based on the sum total of the percentages by weight of (A), (B), (C), (D) and (E), of at least one further additive (D) and
0% to 30% by weight, based on the sum total of the percentages by weight of (A), (B), (C), (D) and (E), of at least one reinforcer (E).

It has been found that, surprisingly, the simultaneous use of at least one flow agent and at least one organic additive, especially one organic additive selected from the group consisting of polyethylene waxes, polypropylene waxes, maleic acid- and/or maleic anhydride-grafted polypropylene waxes, amide waxes, fatty acid esters and glycerol fatty acid esters, significantly improves both the flowability and coalescence of the sinter powder in the sintering operation without any adverse effect of the use of the at least one flow agent and the at least one organic additive on the mechanical properties of the shaped body produced. The shaped bodies produced from the sinter powder of the invention have both high tensile strength and high elongation at break.

Moreover, the use of the at least one flow agent and the at least one organic additive also optimizes the production of the sinter powder per se. The improved flowability accelerates comminution steps such as grinding and/or sieving since blockage of the sieve is avoided. This leads to improved economic viability and process stability.

Sinter Powder (SP)

According to the invention, the sinter powder (SP) comprises as component (A) 59.5% to 99.85% by weight of at least one thermoplastic polyurethane, as component (B) 0.05% to 0.5% by weight of at least one flow agent, as component (C) 0.1% to 5% by weight of at least one organic additive (C), as component (D) 0% to 5% by weight of at least one further additive (D), and as component (E) 0% to 30% by weight of at least one reinforcer (E), based in each case on the sum total of the percentages by weight of (A), (B), (C), (D) and (E), preferably based on the total weight of the sinter powder (SP).

The percentages by weight of components (A), (B), (C), (D) and (E) typically add up to 100% by weight.

In the context of the present invention the terms “component (A)” and “at least one thermoplastic polyurethane” are used synonymously and therefore have the same meaning.

The same applies to the terms “component (B)” and “at least one flow agent”. These terms are likewise used synonymously in the context of the present invention and therefore have the same meaning.

Correspondingly, the terms “component (C)” and “at least one organic additive” are also used synonymously and have the same meaning.

The terms “component (D)” and “at least one further additive”, and “component (E)” and “at least one reinforcer”, are also each used synonymously in the context of the present invention and therefore have the same meaning.

The sinter powder (SP) preferably comprises in the range from 74.15% to 99.7% by weight of component (A), in the range from 0.1% to 0.35% by weight of component (B), in the range from 0.2% to 3% by weight of component (C), in the range from 0% to 2.5% by weight of component (D) and in the range from 0% to 20% by weight of component (E), based in each case on the sum total of the percentages by weight of components (A), (B), (C), (D) and (E), preferably based on the total weight of the sinter powder (SP).

The sinter powder (SP) most preferably comprises in the range from 76.12% to 99.42% by weight of component (A), in the range from 0.18% to 0.28% by weight of component (B), in the range from 0.4% to 1.1% by weight of component (C), in the range from 0% to 2.5% by weight of component (D) and in the range from 0% to 20% by weight of component (E), based in each case on the sum total of the percentages by weight of components (A), (B), (C), (D) and (E), preferably based on the total weight of the sinter powder (SP).

If the sinter powder (SP) comprises component (D), it may comprise, for example, in the range from 0.1% to 5% by weight of component (D), preferably in the range from 0.2% to 2.5% by weight of component (D), based on the sum total of the percentages by weight of components (A), (B), (C), (D) and (E), preferably based on the total weight of the sinter powder (SP).

If the sinter powder (SP) comprises component (E), it may comprise, for example, in the range from 5% to 30% by weight of component (E), preferably in the range from 10% to 20% by weight of component (E), based on the sum total of the percentages by weight of components (A), (B), (C), (D) and (E), preferably based on the total weight of the sinter powder (SP).

If the sinter powder (SP) comprises component (D) and/or component (E), the percentages by weight of the at least one thermoplastic polyurethane (A) present in the sinter powder (SP) are typically correspondingly reduced, such that the sum total of the percentages by weight of the at least one thermoplastic polyurethane (A), of component (B), of component (C) and of component (D) and/or of component (E) adds up to 100% by weight.

If the sinter powder (SP) comprises component (D), it thus comprises, for example, in the range from 59.5% to 99.75% by weight of component (A), in the range from 0.05% to 0.5% by weight of component (B), in the range from 0.1% to 5% by weight of component (C), in the range from 0.1% to 5% by weight of component (D) and in the range from 0% to 30% by weight of component (E), based on the sum total of the percentages by weight of components (A), (B), (C), (D) and (E), preferably based on the total weight of the sinter powder (SP).

If the sinter powder (SP) comprises component (D), it thus preferably comprises in the range from 74.15% to 99.5% by weight of component (A), in the range from 0.1% to 0.35% by weight of component (B), in the range from 0.2% to 3% by weight of component (C), in the range from 0.2% to 2.5% by weight of component (D) and in the range from 0% to 20% by weight of component (E), based on the sum total of the percentages by weight of components (A), (B), (C), (D) and (E), preferably based on the total weight of the sinter powder (SP).

If the sinter powder (SP) comprises component (D), it thus more preferably comprises in the range from 76.12% to 99.22% by weight of component (A), in the range from 0.18% to 0.28% by weight of component (B), in the range from 0.4% to 1.1% by weight of component (C), in the range from 0.2% to 2.5% by weight of component (D) and in the range from 0% to 20% by weight of component (E), based on the sum total of the percentages by weight of components (A), (B), (C), (D) and (E), preferably based on the total weight of the sinter powder (SP).

If the sinter powder (SP) comprises component (E), it thus comprises, for example, in the range from 59.5% to 94.85% by weight of component (A), in the range from 0.05% to 0.5% by weight of component (B), in the range from 0.1% to 5% by weight of component (C), in the range from 0% to 5% by weight of component (D) and in the range from 5% to 30% by weight of component (E), based on the sum total of the percentages by weight of components (A), (B), (C), (D) and (E), preferably based on the total weight of the sinter powder (SP).

If the sinter powder (SP) comprises component (E), it thus preferably comprises in the range from 74.15% to 89.7% by weight of component (A), in the range from 0.1% to 0.35% by weight of component (B), in the range from 0.2% to 3% by weight of component (C), in the range from 0% to 2.5% by weight of component (D) and in the range from 10% to 20% by weight of component (E), based on the sum total of the percentages by weight of components (A), (B), (C), (D) and (E), preferably based on the total weight of the sinter powder (SP).

If the sinter powder (SP) comprises component (E), it thus more preferably comprises in the range from 76.12% to 89.42% by weight of component (A), in the range from 0.18% to 0.28% by weight of component (B), in the range from 0.4% to 1.1% by weight of component (C), in the range from 0% to 2.5% by weight of component (D) and in the range from 10% to 20% by weight of component (E), based on the sum total of the percentages by weight of components (A), (B), (C), (D) and (E), preferably based on the total weight of the sinter powder (SP).

If the sinter powder (SP) comprises components (D) and (E), it thus comprises, for example, in the range from 59.5% to 94.75% by weight of component (A), in the range from 0.05% to 0.5% by weight of component (B), in the range from 0.1% to 5% by weight of component (C), in the range from 0.1% to 5% by weight of component (D) and in the range from 5% to 30% by weight of component (E), based on the sum total of the percentages by weight of components (A), (B), (C), (D) and (E), preferably based on the total weight of the sinter powder (SP).

If the sinter powder (SP) comprises components (D) and (E), it thus preferably comprises in the range from 74.15% to 89.5% by weight of component (A), in the range from 0.1% to 0.35% by weight of component (B), in the range from 0.2% to 3% by weight of component (C), in the range from 0.2% to 2.5% by weight of component (D) and in the range from 10% to 20% by weight of component (E), based on the sum total of the percentages by weight of components (A), (B), (C), (D) and (E), preferably based on the total weight of the sinter powder (SP).

If the sinter powder (SP) comprises components (D) and (E), it thus more preferably comprises in the range from 76.12% to 89.22% by weight of component (A), in the range from 0.18% to 0.28% by weight of component (B), in the range from 0.4% to 1.1% by weight of component (C), in the range from 0.2% to 2.5% by weight of component (D) and in the range from 10% to 20% by weight of component (E), based on the sum total of the percentages by weight of components (A), (B), (C), (D) and (E), preferably based on the total weight of the sinter powder (SP).

The sinter powder (SP) typically comprises particles. These particles have, for example, a size (D50) in the range from 10 to 190 μm, preferably in the range from 15 to 150 μm, more preferably in the range from 20 to 110 μm and especially preferably in the range from 40 to 100 μm.

In the context of the present invention, the “D50” is to be understood to mean the particle size at which 50% by volume of the particles based on the total volume of the particles are smaller than or equal to the D50 and 50% by volume of the particles based on the total volume of the particles are larger than the D50.

The D50 is determined in the context of the present invention by means of laser diffraction to ISO 13320 (Horiba LA-960, Retsch Technology, Germany) with dry dispersion at 1 bar. The evaluation is effected with the aid of the Fraunhofer method.

The sinter powder (SP) typically has a melting temperature (T_{M(SP)}) in the range from 80 to 220° C. Preferably, the melting temperature (T_{M(SP)}) of the sinter powder (SP) is in the range from 100 to 190° C. and especially preferably in the range from 120 to 170° C.

In the context of the present invention, the melting temperature (T_{M(SP)}) is determined to DIN EN ISO 11357 by means of differential scanning calorimetry (DSC; Discovery series DSC, TA Instruments). During the measurement under a nitrogen atmosphere, the sample is subjected to the following temperature cycle: 5 minutes at −80° C., then heating to at least 200° C. at 20° C./min (1st heating run (H1)), then 5 minutes at at least 200° C., then cooling to −80° C. at 20° C./min, then 5 minutes at −80° C., then heating to at least 200° C. at 20° C./min (2nd heating run (H2)). This affords a DSC diagram as shown by way of example in FIG. 1. The terms “melt onset (T_{M}^{onset})” and “melt endset (T_{M}^{endset})” are known to the person skilled in the art. They respectively correspond to the start (onset) and the end (endset) of the melting peak. The melting temperature (T_{M(SP)}) is understood to mean the temperature at which the melting peak of the first heating run (H1) of the DSC diagram has a maximum. If multiple local maxima occur in the range between T_{M}^{onset} and T_{M}^{endset}, the melting temperature (T_{M(SP)}) is understood to mean the numerical average of the respective local maxima.

The sinter powder (SP) typically also has a melt volume flow rate (MVR) in the range from 3 to 150 cm³/10 min. Preferably, the melt volume flow rate of the sinter powder (SP) is in the range from 15 to 100 cm³/10 min, more preferably in the range from 30 to 70 cm³/10 min.

In the context of the present invention, the melt volume flow rate is ascertained to DIN EN ISO 1133 (mi2.1, Gottfert, Germany). For this purpose, the sinter powder (SP) is predried in nitrogen at 110° C. for 2 hours and then analyzed with a load of 2.16 kg and at a temperature=(T_{m(SP)}+40° C.).

The sinter powder (SP) typically also has a bulk density of ≥300 g/L, preferably of ≥350 g/L and more preferably of ≥400 g/L.

In the context of the present invention, the bulk density is determined to DIN EN ISO 60. It may be used as a measure of the flowability of the sinter powder (SP). The higher the bulk density, the higher the flowability of the sinter powder (SP).

The sinter powder (SP) can be produced by any methods known to those skilled in the art. For example, the sinter powder is produced by grinding, by precipitation, by melt emulsification or by microgranulation.

If the sinter powder (SP) is produced by precipitation, component (A) is typically mixed with a solvent and dissolved in the solvent, optionally while heating, to obtain a solution. The TPU powder is subsequently precipitated, for example by cooling the solution, distilling the solvent out of the solution or adding a precipitant to the solution.

Components (B), (C) and optionally (D) and (E) are typically mixed into the dry TPU powder to obtain the sinter powder (SP).

The grinding can be conducted by any methods known to those skilled in the art; for example, components (A), (B) and (C) and optionally (D) and (E) are introduced into a mill and ground therein.

Suitable mills include all mills known to those skilled in the art, for example classifier mills, opposed jet mills, hammer mills, ball mills, vibratory mills or rotor mills such as pinned disk mills and whirlwind mills. The particle size is typically adjusted by means of a sieving machine disposed downstream of the mill. In a preferred embodiment, a long mesh sieve is used. The use of a long mesh sieve allows the proportion of the good fraction to be increased. The mesh size of the sieve should be chosen such that the abovementioned D50 of the sinter powder (SP) can be established.

The grinding in the mill can likewise be effected by any methods known to those skilled in the art. For example, the grinding can take place under inert gas and/or while cooling with liquid nitrogen. Cooling with liquid nitrogen is preferred. The temperature in the grinding is as desired; the grinding is preferably performed at liquid nitrogen temperatures, for example at a temperature in the range from −210 to −195° C. The temperature of the components on grinding in that case is, for example, in the range from −60 to 0° C.

Preferably, at least component (A) is in the form of a granular material prior to the grinding. The granular material may, for example, be spherical, cylindrical or ellipsoidal.

The method of producing a sinter powder (SP) comprising
59.5% to 99.85% by weight, based on the total weight of the sinter powder (SP), of at least one thermoplastic polyurethane (A),
0.05% to 0.5% by weight, based on the total weight of the sinter powder (SP), of at least one flow agent (B),
0.1% to 5% by weight, based on the total weight of the sinter powder (SP), of at least one organic additive (C),
0% to 5% by weight, based on the total weight of the sinter powder (SP), of at least one further additive (D) and
0% to 30% by weight, based on the total weight of the sinter powder (SP), of at least one reinforcer (E),

in that case comprises, in one embodiment, the step of
a) grinding the total amount, based on the total weight of the sinter powder (SP), of component (A),
wherein a first portion (BT1) of the total amount, based on the total weight of the sinter powder (SP), of component (B) and/or a first portion (CT1) of the total amount, based on the total weight of the sinter powder (SP), of component (C) are mixed into component (A) prior to step a) to obtain a powder (P), and the remaining portion (BT2) of the total amount of component (B) and/or the remaining portion (CT2) of the total amount of component (C) are mixed into the powder (P) after step a) to obtain the sinter powder (SP), wherein the first portion (BT1) accounts for 0% to 100% by weight of the total amount, based on the total weight of the sinter powder (SP), of component (B) and wherein the first portion (CT1) accounts for 0% to 100% by weight of the total amount, based on the total weight of the sinter powder (SP), of component (C), and wherein the remaining portion (BT2) accounts for (100−BT1)% by weight of the total amount, based on the total weight of the sinter powder (SP), of component (B) and the remaining portion (CT2) accounts for (100−CT1)% by weight of the total amount, based on the total weight of the sinter powder (SP), of component (C),
and wherein optionally
the total amount, based on the total weight of the sinter powder (SP), of component (D) and/or
the total amount, based on the total weight of the sinter powder (SP), of component (E) is mixed in before step a) or after step a).

Preferably, the at least one organic additive (C) is added to component (A) prior to the grinding operation. This can significantly increase the throughput during the grinding operation.

Methods of mixing are known as such to the person skilled in the art. Typically, components (B) and/or (C) and optionally components (D) and/or (E) are mixed into component (A) in dry form. However, it is also possible that the mixing is effected via compounding in an extruder, especially preferably in a twin-screw extruder. However, it is also possible that a combination of partial compounding and partial dry mixing is used.

In respect of the grinding in step a), the details and preferences described above are correspondingly applicable with regard to the grinding.

In a preferred embodiment, the at least one thermoplastic polyurethane (A) is heated prior to step a).

Preferably, the at least one thermoplastic polyurethane (A) is heated at a temperature T_{T} at most 100° C. below the melting temperature (T_{M(A)}) of the at least one thermoplastic polyurethane (A), more preferably at a temperature T_{T} at most 70° C. below the melting temperature (T_{M(A)}) of the at least one thermoplastic polyurethane (A), and especially preferably at a temperature T_{T} at most 40° C. below the melting temperature (T_{M(A)}) of the at least one thermoplastic polyurethane (A).

In addition, the at least one thermoplastic polyurethane (A) is preferably heated at a temperature T_{T} at least 5° C. below the melting temperature (T_{M(A)}) of the at least one thermoplastic polyurethane (A), more preferably at a temperature T_{T} at least 10° C. below the melting temperature (T_{M(A)}) of the at least one thermoplastic polyurethane (A), and especially preferably at a temperature T_{T} at least 20° C. below the melting temperature (T_{M(A)}) of the at least one thermoplastic polyurethane (A).

The at least one thermoplastic polyurethane (A) is preferably heated for at least 10 hours, more preferably at least 24 hours and especially preferably at least 48 hours. Preferably, the at least one thermoplastic polyurethane (A) is heated for 7 days. The heating is preferably effected in a paddle drier (>4 t) under reduced pressure or under protective gas. The protective gas used is, for example, nitrogen.

The present invention therefore also further provides the sinter powder (SP) obtainable by the method of the invention.

Component (A)

According to the invention, component (A) is at least one thermoplastic polyurethane.

In the context of the present invention, “at least one thermoplastic polyurethane” means either exactly one thermoplastic polyurethane (A) or a mixture of two or more thermoplastic polyurethanes (A). In addition, the term “at least one thermoplastic polyurethane” in the context of the present invention means a mixture of at least one thermoplastic polyurethane and at least one further polymer miscible with the at least one thermoplastic polyurethane. “At least one further polymer miscible with the thermoplastic polyurethane” in the context of the present invention means either exactly one further polymer miscible with the thermoplastic polyurethane or a mixture of two or more polymers miscible with the thermoplastic polyurethane.

The at least one thermoplastic polyurethane (A) may be produced by any methods known to the person skilled in the art.

In a preferred embodiment, the at least one thermoplastic polyurethane (A) is prepared by reacting the following components:
a) at least one isocyanate,
b) at least one isocyanate-reactive compound, and
c) optionally at least one chain extender having a number-average molecular weight M_{N} in the range from 50 to 499 g/mol,
optionally in the presence of
d) at least one catalyst,
e) at least one additive and/or
f) at least one reinforcer.

In the context of the present invention, the number-average molecular weight M_{N} is determined by means of gel permeation chromatography.

Component (A) preferably has a weight-average molecular weight M_{W} of at least 100 000 g/mol, more preferably of at least 400 000 g/mol and especially preferably of at least 600 000 g/mol. Component (A) also preferably has a weight-average molecular weight M_{W} of at most 800 000 g/mol.

In the context of the present invention, the weight-average molecular weight M_{W} is determined by means of gel permeation chromatography.

The at least one thermoplastic polyurethane typically has a melting temperature (T_{M(A)}) in the range from 80 to 220° C. Preferably, the melting temperature (T_{M(A)}) of the at least one thermoplastic polyurethane is in the range from 100 to 190° C., more preferably in the range from 120 to 170° C. and especially preferably in the range from 135 to 145° C.

In the context of the present invention, the melting temperature (T_{M(A)}) is determined to DIN EN ISO 11357 by means of differential scanning calorimetry (DSC; Discovery series DSC, TA Instruments). During the measurement under a nitrogen atmosphere, the sample is subjected to the following temperature cycle: 5 minutes at −80° C., then heating to at least 200° C. at 20° C./min (1st heating run (H1)), then 5 minutes at at least 200° C., then cooling to −80° C. at 20° C./min, then 5 minutes at −80° C., then heating to at least 200° C. at 20° C./min (2nd heating run (H2)). This affords a DSC diagram as shown by way of example in FIG. 1. The terms “melt onset (T_{M}^{onset})” and “melt endset (T_{M}^{endset})” are known to the person skilled in the art. They respectively correspond to the start (onset) and the end (endset) of the melting peak. The melting temperature (T_{M(SP)}) is understood to mean the temperature at which the melting peak of the first heating run (H1) of the DSC diagram has a maximum. If multiple local maxima occur in the range between T_{M}^{onset} and T_{M}^{endset}, the melting temperature (T_{M(SP)}) is understood to mean the numerical average of the respective local maxima.

Component (a))

Component (a)) is at least one isocyanate.

In the context of the present invention, “at least one isocyanate” means either exactly one isocyanate or a mixture of two or more isocyanates.

The at least one isocyanate may be an aliphatic, cycloaliphatic, araliphatic and/or aromatic isocyanate.

Component (a)) is preferably a diisocyanate, for example selected from the group consisting of trimethylene diisocyanate, tetramethylene diisocyanate, pentamethylene diisocyanate, hexamethylene 1,6-diisocyanate (HDI), heptamethylene diisocyanate, octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane (1,4-HXDI), 1,3-bis(isocyanatomethyl)cyclohexane (1,3-HXDI), paraphenylene 2,4-diisocyanate (PPDI), tetramethylenexylene 2,4-diisocyanate (TMXDI), dicyclohexylmethane 4,4′-, 2,4′- and 2,2′-diisocyanate (H12 MDI), cyclohexane 1,4-diisocyanate, 1-methylcyclohexane 2,4- and 2,6-diisocyanate, diphenylmethane 2,2′-diisocyanate (2,2′-MDI), diphenylmethane 2,4′-diisocyanate (2,4′-MDI) and diphenylmethane 4,4′-diisocyanate (4,4′-MDI), naphthylene 1,5-diisocyanate (NDI), tolylene 2,4-diisocyanate (2,4-TDI) and tolylene 2,6-diisocyanate (2,6-TDI), diphenylmethane diisocyanate, 3,3′-dimethyldiphenyl diisocyanate, diphenylethane 1,2-diisocyanate and phenylene diisocyanate.

More preferably, component (a)) is diphenylmethane 4,4′-diisocyanate (4,4′-MDI).

Component (b))

Component (b)) is at least one isocyanate-reactive compound.

In the context of the present invention “at least one isocyanate-reactive compound” is understood to mean either exactly one isocyanate-reactive compound or a mixture of two or more isocyanate-reactive compounds.

Component (b)) preferably has a number-average molecular weight M_{N} in the range from 500 to 100 000 g/mol, more preferably in the range from 500 to 8000 g/mol, especially preferably in the range from 700 to 6000 g/mol and in particular in the range from 800 to 4000 g/mol.

The at least one isocyanate-reactive compound (b)) preferably has a statistical average of at least 1.8 and at most 3.0 Zerewitinoff-active hydrogen atoms.

In the context of the present invention, the number of Zerewitinoff-active hydrogen atoms is understood to mean the functionality of the at least one isocyanate-reactive compound (b)). It indicates the amount of the at least one isocyanate-reactive groups in the molecule calculated theoretically for one molecule from a molar amount.

In a preferred embodiment, the functionality is in the range from 1.8 to 2.6 and preferably in the range from 1.9 to 2.2. In particular, the functionality is 2.

The at least one isocyanate-reactive compound is preferably linear.

It is preferably used with a molar proportion of 1 equivalent mol % to 80 equivalent mol %, based on the isocyanate group content of the at least one isocyanate.

Preferably, the at least one isocyanate-reactive compound (component (b))) has a reactive group selected from the group consisting of hydroxyl group, amino group, mercapto group and carboxylic acid group; more preferably, the at least one isocyanate-reactive compound (component (b))) has a hydroxyl group.

In one embodiment which is preferred in the context of the present invention, the at least one isocyanate-reactive compound (component (b))) is selected from the group consisting of polyesterdiols, polyetherdiols and polycarbonatediols. The at least one isocyanate-reactive compound (component (b))) is preferably a polyesterdiol such as polycaprolactone and/or a polyetherdiol, for example based on ethylene oxide, propylene oxide and/or butylene oxide. A particularly preferred polyether is polytetrahydrofuran (PTHF).

Isocyanate-reactive compounds (component (b))) selected are more preferably compounds from the group consisting of copolyesters based on adipic acid, succinic acid, pentanedioic acid and/or sebacic acid and mixtures of ethane-1,2-diol and butane-1,4-diol, copolyesters based on adipic acid, succinic acid, pentanedioic acid and/or sebacic acid and mixtures of butane-1,4-diol and hexane-1,6-diol, and polyesters based on adipic acid, succinic acid, pentanedioic acid and/or sebacic acid and 3-methylpentane-1,5-diol and/or polytetramethylene glycol (polytetrahydrofuran, PTHF), preferably copolyesters based on adipic acid and mixtures of ethane-1,2-diol and butane-1,4-diol and polyesters based on adipic acid, succinic acid, pentanedioic acid and/or sebacic acid and polytetramethylene glycol (PTHF).

Component (c))

Component (c)) is at least one chain extender having a number-average molecular weight M_{N} in the range from 50 to 499 g/mol.

In the context of the present invention, “at least one chain extender having a number-average molecular weight M_{N} in the range from 50 to 499 g/mol” means either exactly one chain extender having a number-average molecular weight M_{N} in the range from 50 to 499 g/mol or a mixture of two or more chain extenders having a number-average molecular weight M_{N} in the range from 50 to 499 g/mol.

Component (c)) used may be aliphatic, araliphatic, aromatic and/or cycloaliphatic compounds having a number-average molecular weight of 50 g/mol to 499 g/mol.

Preferably, component (c)) has two isocyanate-reactive groups.

Preferred chain extenders are therefore diamines and/or alkanediols, more preferred chain extenders are alkanediols having 2 to 10 carbon atoms and especially preferred chain extenders are alkanediols having 3 to 8 carbon atoms, in the alkylene radical. It is further preferable that the alkanediols have solely primary hydroxyl groups.

In a preferred embodiment, component (c)) is selected from the group consisting of di-, tri-, tetra-, penta-, hexa-, hepta-, octa-, nona- and decaalkylene glycols, cyclohexane-1,4-diol, cyclohexane-1,4-dimethanol, neopentyl glycol and hydroquinone bis(beta-hydroxyethyl) ether (HQEE).

Suitable di-, tri-, tetra-, penta-, hexa-, hepta-, octa-, nona- and decaalkylene glycols are, for example, 1,2-ethylene glycol, propane-1,2-diol, propane-1,3-diol, butane-1,4-diol, butane-2,3-diol, pentane-1,5-diol, hexane-1,6-diol, diethylene glycol, oligo- and polypropylene glycols.

In the context of the present invention, chain extenders (component (c))) used are preferably 1,2-ethylene glycol, propane-1,3-diol, butane-1,4-diol and hexane-1,6-diol, more preferably 1,2-ethylene glycol, butane-1,4-diol and hexane-1,6-diol.

In the preparation of softer thermoplastic polyurethanes, the molar ratio of component (b)) (at least one isocyanate-reactive compound) to component (c)) (at least one chain extender having a number-average molecular weight M_{N} in the range from 50 to 499 g/mol) is preferably in the range from 1:1 to 1:5, more preferably in the range of 1:1.5 to 1:4.5.

If components (b)) and (c)) are mixed in this case, the hydroxyl equivalent weight is preferably >200; the hydroxyl equivalent weight is more preferably in the range from 230 to 450.

In the preparation of harder thermoplastic polyurethanes, for example of thermoplastic polyurethanes having a Shore A hardness of >98, preferably of thermoplastic polyurethanes having a Shore D hardness in the range from 55 to 75, the molar ratio of component (b)) (at least one isocyanate-reactive compound) to component (c)) (at least one chain extender having a number-average molecular weight M_{N} in the range from 50 to 499 g/mol) is preferably in the range from 1:5.5 to 1:15, more preferably in the range of 1:6 to 1:12.

If components (b)) and (c)) are mixed in this case, the hydroxyl equivalent weight is preferably in the range from 110 to 200, more preferably in the range from 120 to 180.

The equivalence ratio of the NCO groups of component (a)) (at least one isocyanate) to the sum total of the OH groups of components (b)) and (c)) is preferably in the range from 0.95:1 to 1.10:1, more preferably in the range from 0.98:1 to 1.08:1 and especially preferably in the range from 1:1 to 1.05:1.

Component (d))

Component (d)) is at least one catalyst.

In the context of the present invention “at least one catalyst (d))” means either exactly one catalyst (d)) or a mixture of two or more catalysts (d)).

Catalysts as such are known to those skilled in the art. In the context of the present invention, preference is given to using catalysts that accelerate the reaction between the NCO groups of the isocyanates (component (a))) and the hydroxyl groups of the isocyanate-reactive compound (component (b))) and, if used, the chain extender (component (c))).

Suitable catalysts are, for example, tertiary amines, especially triethylamine, dimethylcyclohexylamine, N-methylmorpholine, N,N′-dimethylpiperazine, 2-(dimethylaminoethoxy)ethanol and diazabicyclo[2.2.2]octane.

In the context of the present invention, preference is given to using organic metal compounds, for example titanic esters, iron compounds, tin compounds and bismuth salts.

An example of a suitable iron compound is iron(III) acetylacetonate. Suitable tin compounds are, for example, tin dialkyl salts, tin diacetate, tin dioctoate and tin dilaurate; preferred tin compounds are dibutyltin diacetate and dibutyltin dilaurate. An example of a suitable bismuth salt is bismuth decanoate.

Catalysts particularly preferred in the context of the present invention are titanic esters, tin dioctoate and bismuth decanoate.

If a catalyst (d)) is used, it is preferably used in amounts of 0.0001 to 0.1 part by weight per 100 parts by weight of the isocyanate-reactive compound (component (b))).

Component (e))

Component (e)) is at least one additive.

In the context of the present invention, “at least one additive (e))” means either exactly one additive (e)) or a mixture of two or more additives (e)).

The at least one additive (e)) may be either the same as the at least one further additive (D) described further down or different than the at least one further additive (D) described further down. It is preferably different than the at least one further additive (D) described further down.

However, the at least one additive (e)) and the at least one further additive (D) differ in the manner of their addition. While the at least one additive (e)) is preferably added to the reaction mixture during the synthesis of component (A) and hence incorporated into the TPU polymer or added to component (A) directly after the synthesis of component (A), the at least one further additive (D) is only added directly before, during or after the production of the sinter powder (SP) of component (A).

Preferably, the at least one additive (e)) is selected from the group consisting of surface-active substances, flame retardants, nucleating agents, oxidation stabilizers, lubricating and demolding aids, dyes and pigments, stabilizers against hydrolysis, light, heat or discoloration, and plasticizers.

Examples of suitable stabilizers are, for example, primary and secondary antioxidants, sterically hindered phenols, hindered amine light stabilizers (HALS), UV absorbers, hydrolysis stabilizers, quenchers and flame retardants. Examples of commercially available stabilizers are found in Plastics Additives Handbook, 5th edition, H. Zweifel, ed., Hanser Publishers, Munich, 2001 ([1]), pp. 98-136.

Suitable UV absorbers preferably have a number-average molecular weight M_{N} of at least 300 g/mol, more preferably of at least 390 g/mol. In addition, suitable UV absorbers preferably have a number-average molecular weight M_{N} of at most 5000 g/mol, more preferably of at most 2000 g/mol.

Particularly suitable UV absorbers are UV absorbers selected from the group consisting of cinnamates, oxanilides and benzotriazoles, particular preference being given to benzotriazoles. Examples of particularly suitable benzotriazoles are Tinuvin® 213, Tinuvin® 234, Tinuvin® 312, Tinuvin® 571, and Tinuvin® 384 and Eversorb® 82.

Typically, the UV absorbers are dosed in amounts of 0.01% to 5% by weight, based on the mass of components (a)), (b)) and (e)), preferably in amounts of 0.1% to 2.0% by weight, especially in amounts of 0.2% to 0.5% by weight.

Suitable hindered amine light stabilizers preferably have a number-average molecular weight M_{N} of at least 500 g/mol. In addition, suitable hindered amine light stabilizers preferably have a number-average molecular weight M_{N} of at most 10 000 g/mol, more preferably of at most 5000 g/mol.

Particularly preferred hindered amine light stabilizers (HALS) are bis(1,2,2,6,6-pentamethylpiperidyl) sebacate (Tinuvin® 765, Ciba Spezialitatenchemie AG) and the condensation product of 1-hydroxyethyl-2,2,6,6-tetramethyl-4-hydroxypiperidine and succinic acid (Tinuvin® 622). Especially preferred is the condensation product of 1-hydroxyethyl-2,2,6,6-tetramethyl-4-hydroxypiperidine and succinic acid (Tinuvin® 622) when the titanium content of the finished product is less than 150 ppm, preferably less than 50 ppm, especially less than 10 ppm, based on components (a)) and (b)).

Typically, the HALS are dosed in amounts of 0.01% to 5% by weight, based on the mass of components (a)), (b)) and (e)), preferably in amounts of 0.1% to 1.0% by weight, especially in amounts of 0.15% to 0.3% by weight.

A particularly preferred stabilization comprises a mixture of a phenolic stabilizer, a benzotriazole and a HALS compound in the above-described preferred amounts.

Component (f))

Component (f)) is at least one reinforcer.

In the context of the present invention, “at least one reinforcer (f))” means either exactly one reinforcer (f)) or a mixture of two or more reinforcers (f)).

The at least one reinforcer (f)) may be either the same as the at least one reinforcer (E) described further down or different than the at least one reinforcer (E) described further down.

For example, the at least one reinforcer (f)) is selected from the group consisting of carbon nanotubes, carbon fibers, boron fibers, glass fibers, glass beads, silica fibers, ceramic fibers, basalt fibers, aluminum silicates, aramid fibers and polyester fibers.

The at least one reinforcer (f)) may be added to the reaction mixture in the course of production of component (A), in which case it may be added in dry form or as a masterbatch.

However, it is also possible that no reinforcer (f)) is added in the course of production of component (A) of the reaction mixture. In this case, it is possible that at least one reinforcer (E) described further down is added to components (A), (B), (C) and optionally (D) in the course of production of the sinter powder (SP).

It is of course also possible in the course of production of component (A) to add at least one reinforcer (f)) to the reaction mixture and then to add at least one reinforcer (E) to components (A), (B), (C) and optionally (D) in the course of production of the sinter powder (SP).

Production of Component (A)

The at least one thermoplastic polymer (A) may be produced in a batchwise process or a continuous process. For example, the at least one thermoplastic polymer (A) is produced with reactive extruders or by the belt process, by the one-shot or prepolymer method, preferably by the one-shot method.

In the one-shot method, components (a)) and (b)) and optionally also components (c)), (d)) and/or (e)) are mixed with one another simultaneously or successively, with immediate onset of the polymerization reaction.

In the extruder method, components (a)) and (b)), and optionally also components (c)), (d)) and/or (e)), are introduced into the extruder individually or in the form of a mixture and reacted, preferably at temperatures of 100° C. to 280° C., more preferably at temperatures of 140° C. to 250° C. The polyurethane obtained is extruded, cooled and pelletized. It is preferably in the form of granules or powder.

It is preferable to use a twin-screw extruder, because the twin-screw extruder operates in force-conveying mode and thus permits greater precision of adjustment of the temperature and quantitative output in the extruder.

Thermoplastic polyurethanes of the invention are available, for example, under the Elastollan® SP9415 trade name from BASF (BASF Polyurethanes GmbH, Lemforde, Germany).

Component (B)

According to the invention, component (B) is at least one flow agent.

In the context of the present invention, “at least one flow agent (B)” means either exactly one flow agent (B) or a mixture of two or more flow agents (B).

Flow agents as such are known to those skilled in the art. In the context of the present invention, the at least one flow agent (B) is preferably an inorganic compound.

The at least one flow agent (B) is selected, for example, from the group consisting of silicon dioxide (silica), silicates, silicas, metal oxides, minerals, borates, phosphates, sulfates and carbonates.

Examples of suitable silicon dioxides (silica compounds) are hydrated silicon dioxides, vitreous silicon dioxides and pyrogenic silicon dioxides.

Examples of suitable silicates are aluminosilicates, alkali metal silicates, alkaline earth metal silicates, alkali metal aluminosilicates, alkaline earth metal aluminosilicates, calcium silicates and magnesium silicates.

Examples of suitable silicas are hydrophobic fumed silicas.

Examples of suitable metal oxides are aluminum oxide, titanium dioxide and vitreous oxides.

Examples of suitable minerals are talc, mica, kaolin and attapulgite.

Examples of suitable borates and phosphates are vitreous borates and vitreous phosphates.

Examples of suitable sulfates are magnesium sulfate, calcium sulfate and barium sulfate.

Examples of suitable carbonates are magnesium carbonate, calcium carbonate and barium carbonate.

Preferably, the at least one flow agent (B) is selected from the group consisting of hydrophobic fumed silicas, talc, kaolin, magnesium sulfate, calcium sulfate, barium sulfate, magnesium carbonate, calcium carbonate and barium carbonate.

The at least one flow agent (B) typically comprises particles. These particles have, for example, a size (D90) of 10 μm, preferably 2 μm.

In the context of the present invention, the “D90” is to be understood to mean the particle size at which 90% by volume of the particles based on the total volume of the particles are smaller than or equal to the D90 and 10% by volume of the particles based on the total volume of the particles are larger than the D90.

The D90 is determined in the context of the present invention by means of laser diffraction to ISO 13320 (Horiba LA-960, Retsch Technology, Germany), preceded by dry dispersion of the sinter powder (SP) or the at least one flow agent (B) at 1 bar. The evaluation is effected with the aid of the Fraunhofer method.

The sinter powder (SP) preferably comprises at least 0.05% by weight, more preferably at least 0.1% by weight and especially preferably at least 0.18% by weight of component (B), based on the sum total of the percentages by weight of components (A), (B), (C), optionally (D) and optionally (E), preferably based on the total weight of the sinter powder (SP).

In addition, the sinter powder (SP) preferably comprises at most 0.5% by weight, more preferably at most 0.35% by weight and especially preferably at most 0.28% by weight of component (B), based on the sum total of the percentages by weight of components (A), (B), (C), optionally (D) and optionally (E), preferably based on the total weight of the sinter powder (SP).

Component (C)

According to the invention, component (C) is at least one organic additive.

In the context of the present invention, “at least one organic additive” means either exactly one organic additive or a mixture of two or more organic additives.

For example, the at least one organic additive (C) is selected from the group consisting of polyethylene waxes, polypropylene waxes, maleic acid- and/or maleic anhydride-grafted polypropylene waxes, amide waxes, fatty acid esters and glycerol fatty acid esters.

Component (C) is preferably at least one organic additive selected from maleic acid- and/or maleic anhydride-grafted polypropylene waxes and amide waxes. Component (C) is more preferably an N,N′-alkylene fatty acid diamide. Component (C) is most preferably N,N′-ethylenedi(stearamide).

Suitable organic additives are obtainable, for example, from Clariant or Baerlocher. One example of a suitable maleic acid- and/or maleic anhydride-grafted polypropylene wax is Licocene PP MA 6452 TP from Clariant.

In the context of the present invention, “maleic acid- and/or maleic anhydride-grafted” means that the polypropylene waxes are branched, with polypropylene present in their main chain and maleic acid and/or maleic anhydride in their branched chain.

In a preferred embodiment of the present invention, the at least one organic additive (C) is selected such that the dropping point D_{P} of the at least one organic additive (C) satisfies the following condition (formula I):

(T_{M(A)}−25° C.)≤D_{P}≤(T_{M(A)}+25° C.) (I)

where D_{P} is the dropping point of the at least one organic additive (C) and T_{M(A)} is the melting temperature of the at least one thermoplastic polyurethane (A).

In a more preferred embodiment of the present invention, the at least one organic additive (C) is selected such that the dropping point D_{P} of the at least one organic additive (C) satisfies the following condition (formula II):

(T_{M(A)}−20° C.)≤D_{P}<(T_{M(A)}+20° C.) (II).

In an especially preferred embodiment of the present invention, the at least one organic additive (C) is selected such that the dropping point D_{P} of the at least one organic additive (C) satisfies the following condition (formula III):

(T_{M(A)}−15° C.)≤D_{P}<(T_{M(A)}+15° C.) (III).

Especially preferably, the at least one organic additive (C) is selected such that the dropping point D_{P} of the at least one organic additive (C) satisfies the following condition (formula IV):

T_{M(A),Onset}≤D_{P}<T_{M(A),Endset} (IV),

where T_{M(A),Onset} denotes the start of the melt peak of the at least one thermoplastic polyurethane (A) and T_{M(A),Endset} the end of the melt peak of the at least one thermoplastic polyurethane (A).

If the dropping point D_{P} of the at least one organic additive (C) cannot be determined, the at least one organic additive (C), in a preferred embodiment of the present invention, is selected such that the melting temperature T_{M(C)} of the at least one organic additive (C) satisfies the following condition (formula V):

(T_{M(A)}−25° C.)≤T_{M(c)}<(T_{M(A)}+25° C.) (V),

where T_{M(c)} is the melting temperature of the at least one organic additive (C) and T_{M(A)} is the melting temperature of the at least one thermoplastic polyurethane (A).

In a more preferred embodiment of the present invention, the at least one organic additive (C) is selected such that the melting temperature T_{M(C)} of the at least one organic additive (C) satisfies the following condition (formula VI):

(T_{M(A)}−20° C.)≤T_{M(C)}<(T_{M(A)}+20° C.) (VI).

In an especially preferred embodiment of the present invention, the at least one organic additive (C) is selected such that the melting temperature T_{M(C)} of the at least one organic additive (C) satisfies the following condition (formula VII):

(T_{M(A)}−15° C.)≤T_{M(C)}<(T_{M(A)}+15° C.) (VII).

Especially preferably, the at least one organic additive (C) is then selected such that the melting temperature T_{M(C)} of the at least one organic additive (C) satisfies the following condition (formula VIII):

T_{M(A),Onset}≤T_{M(C)}<T_{M(A),Endset} (VIII),

where T_{M(A),Onset} denotes the start of the melt peak of the at least one thermoplastic polyurethane (A) and T_{M(A),Endset} the end of the melt peak of the at least one thermoplastic polyurethane (A).

In addition, the at least one organic additive (C) is preferably selected such that the total interfacial energy γ_{S} of the sinter powder (SP) is ≤25 m_{N}·m⁻¹, preferably ≤15 mN·m⁻¹, and especially preferably ≤10 mN·m⁻¹. The disperse component of the interfacial energy γ_{S}^{D} should preferably be ≤20 mN·m⁻¹, preferably ≤11 mN·m⁻¹, and especially preferably ≤7 mN·m⁻¹, and the polar component of the interfacial energy γ_{S}^{P} should preferably be ≤5 mN·m⁻¹, preferably ≤4 mN·m⁻¹, and especially preferably ≤3 mN·m⁻¹.

In the context of the present invention, interfacial energy is calculated with the aid of the Owens-Wendt model (Owens, D. K.; Wendt, R. C.; Jour. of Applied Polymer Science, 13, 1741, (1969)).

For this purpose, the pulverulent samples are applied to a self-produced adhesive film (Acronal V215 on PET film). Excess material is removed with an airgun. 8 to 10 drops of test liquids (ethylene glycol, formamide, water) are each applied to the powder layers with a droplet volume of about 1.5 μL. The contact angle θ is determined by droplet contour analysis directly after the first contact with the surface (5 s after the separation of the droplet). The measurement is conducted at 23° C. The analysis unit used is a Drop Shape Analyzer DSA100 (Krüss GmbH, Germany).

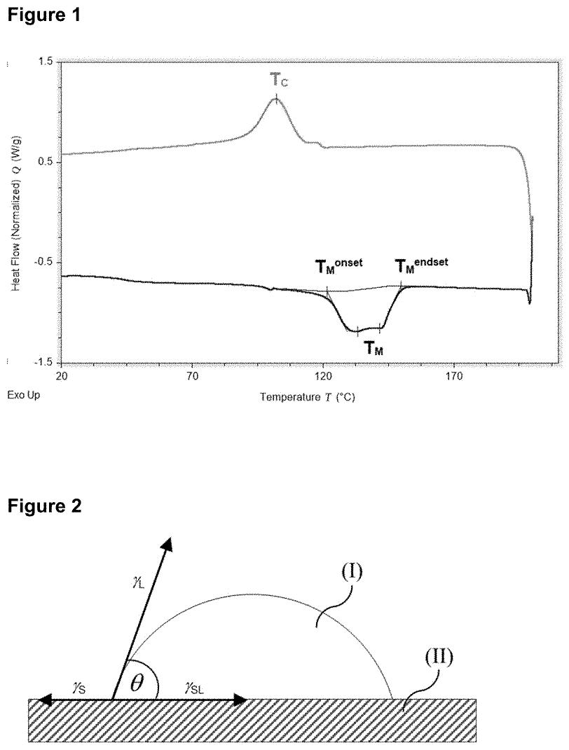

FIG. 2 shows the contact angle θ, the interfacial energy of the test liquid γ_{L}, the interfacial energy of the sinter powder (SP) γ_{S} and the interfacial energy γ_{SL} between test liquid and sinter powder (SP). The contact angle is measured by applying the test liquid (I) to the sample (II).

With the aid of the Owens-Wendt equation (formula IX) and the measured contact angle θ, it is possible by means of linear regression to ascertain the interfacial energy of the powder γ_{S} with the polar component γ_{S}^{P} and the disperse component γ_{S}^{P}:

$$\frac{{γ}_{L} ( 1 + cos θ )}{2 {( {γ}_{L}^{D} )}^{1 / 2}} = {( {γ}_{S}^{P} )}^{1 / 2} \frac{{( {γ}_{L}^{P} )}^{1 / 2}}{{( {γ}_{L}^{D} )}^{1 / 2}} + {( {γ}_{S}^{D} )}^{1 / 2} \qquad ( IX )$$

The following relationships should be noted here (formula X and formula XI):

γ_{L}=γ_{L}^{D}+γ_{L}^{P} (X)

γ_{S}=γ_{S}^{D}+γ_{S}^{P} (XI)

Meaning of the Variables:
θ contact angle
γ_{L} interfacial energy of the test liquid
γ_{L}^{D} disperse component of the interfacial energy of the test liquid
γ_{L}^{P} polar component of the interfacial energy of the test liquid
γ_{S} interfacial energy of the sinter powder (SP)
γ_{S}^{D} disperse component of the interfacial energy of the sinter powder (SP)
γ_{S}^{P} polar component of the interfacial energy of the sinter powder (SP)

The sinter powder (SP) preferably comprises at least 0.1% by weight, more preferably at least 0.2% by weight and especially preferably at least 0.4% by weight of component (C), based on the sum total of the percentages by weight of components (A), (B), (C), optionally (D) and optionally (E), preferably based on the total weight of the sinter powder (SP).

In addition, the sinter powder (SP) preferably comprises at most 5.0% by weight, more preferably at most 3.0% by weight and especially preferably at most 1.1% by weight of component (C), based on the sum total of the percentages by weight of components (A), (B), (C), optionally (D) and optionally (E), preferably based on the total weight of the sinter powder (SP).

Component (D)

Component (D) is at least one further additive.

In the context of the present invention, “at least one further additive” means either exactly one further additive or a mixture of two or more further additives.

Additives as such are known to those skilled in the art. For example, the at least one further additive is selected from the group consisting of antinucleating agents, stabilizers, conductive additives, end group functionalizers, dyes, antioxidants (preferably sterically hindered phenols), flame retardants and color pigments.

An example of a suitable antinucleating agent is lithium chloride. Suitable stabilizers are, for example, phenols, phosphites, metal soaps and copper stabilizers. Suitable conductive additives are carbon fibers, metals, stainless steel fibers, carbon nanotubes and carbon black. Suitable end group functionalizers are, for example, terephthalic acid, adipic acid and propionic acid. Suitable dyes and color pigments are, for example, carbon black and iron chromium oxides. An example of a suitable antioxidant is Irganox® 245 from BASF SE.

Suitable metal soaps are, for example, metal stearates such as magnesium stearate, calcium stearate, zinc stearate and sodium stearate, metal alkylsulfonates such as sodium laurylsulfonate, metal alkylsulfates and metal alkylphosphates.

If the sinter powder (SP) comprises component (D), it preferably comprises at least 0.1% by weight of component (D), more preferably at least 0.2% by weight of component (D), based on the sum total of the percentages by weight of components (A), (B), (C), (D) and (E), preferably based on the total weight of the sinter powder (SP).

If the sinter powder (SP) comprises component (D), it preferably also comprises at most 5% by weight of component (D), more preferably at most 2.5% by weight of component (D), based on the sum total of the percentages by weight of components (A), (B), (C), (D) and (E), preferably based on the total weight of the sinter powder (SP).

Component (E)

According to the invention, any component (E) present is at least one reinforcer.

In the context of the present invention, “at least one reinforcer” means either exactly one reinforcer or a mixture of two or more reinforcers.

In the context of the present invention, a reinforcer is understood to mean a material that improves the mechanical properties of shaped bodies produced by the method of the invention compared to shaped bodies that do not comprise the reinforcer.

Reinforcers as such are known to those skilled in the art. Component (E) may, for example, be in spherical form, in platelet form or in fibrous form.

Preferably, the at least one reinforcer is in spherical form or in platelet form.

In the context of the present invention, “in platelet form” is understood to mean that the particles of the at least one reinforcer have a ratio of diameter to thickness in the range from 4:1 to 10:1, determined by means of microscopy with image evaluation after ashing.

Suitable reinforcers are known to the person skilled in the art and are selected, for example, from the group consisting of carbon nanotubes, glass beads and aluminum silicates.

The at least one reinforcer is preferably selected from the group consisting of glass beads and aluminum silicates. These reinforcers may additionally have been epoxy-functionalized.

Suitable aluminum silicates are known as such to the person skilled in the art. Aluminum silicates refer to compounds comprising Al₂O₃ and SiO₂. In structural terms, a common factor among the aluminum silicates is that the silicon atoms are tetrahedrally coordinated by oxygen atoms and the aluminum atoms are octahedrally coordinated by oxygen atoms. Aluminum silicates may additionally comprise further elements.

Preferred aluminum silicates are sheet silicates. Particularly preferred aluminum silicates are calcined aluminum silicates, especially preferably calcined sheet silicates. The aluminum silicate may additionally have been epoxy-functionalized.

If the at least one reinforcer is an aluminum silicate, the aluminum silicate may be used in any form. For example, it can be used in the form of pure aluminum silicate, but it is likewise possible that the aluminum silicate is used in mineral form. Preferably, the aluminum silicate is used in mineral form. Suitable aluminum silicates are, for example, feldspars, zeolites, sodalite, sillimanite, andalusite and kaolin. Kaolin is a preferred aluminum silicate. Kaolin is one of the clay rocks and comprises essentially the mineral kaolinite. The empirical formula of kaolinite is Al₂[(OH)₄/Si₂O₅]. Kaolinite is a sheet silicate. As well as kaolinite, kaolin typically also comprises further compounds, for example titanium dioxide, sodium oxides and iron oxides. Kaolin preferred in accordance with the invention comprises at least 98% by weight of kaolinite, based on the total weight of the kaolin.

It will be clear to a person skilled in the art that component (E) is different than component (B). Component (E) typically has a higher particle diameter than component (B), meaning that it has, for example, a size (D90)>10 μm.

If the sinter powder comprises component (E), it preferably comprises at least 5% by weight of component (E), more preferably at least 10% by weight of component (E), based on the sum total of the percentages by weight of components (A), (B), (C), (D) and (E), preferably based on the total weight of the sinter powder (SP).

If the sinter powder comprises component (E), it also preferably comprises at most 30% by weight of component (E), more preferably at most 20% by weight of component (E), based on the sum total of the percentages by weight of components (A), (B), (C), (D) and (E), preferably based on the total weight of the sinter powder (SP).

Sintering Method

The present invention further provides a method of producing a shaped body, comprising the steps of:
i) providing a layer of the sinter powder (SP),
ii) exposing or heating the layer of the sinter powder (SP) provided in step i).

In step ii), the layer of the sinter powder (SP) provided in step i) is exposed or heated.

On exposure or heating, at least some of the layer of the sinter powder (SP) melts. The molten sinter powder (SP) coalesces and forms a homogeneous melt. After the exposure, the molten part of the layer of the sinter powder (SP) cools down again and the homogeneous melt solidifies again.

Suitable methods of exposure include any methods known to those skilled in the art. Preferably, the exposure in step ii) is effected with a radiation source. The radiation source is preferably selected from the group consisting of infrared sources and lasers. Especially preferred infrared sources are near-infrared sources.

The present invention therefore also provides a method in which the exposing in step ii) is effected with a radiation source selected from the group consisting of lasers and infrared sources.

Suitable lasers are known to those skilled in the art and are for example fiber lasers, Nd:YAG lasers (neodymium-doped yttrium aluminum garnet lasers) or carbon dioxide lasers. The carbon dioxide laser typically has a wavelength of 10.6 μm.

If the radiation source used in the exposing in step ii) is a laser, the layer of the sinter powder (SP) provided in step i) is typically exposed locally and briefly to the laser beam. This selectively melts just the parts of the sinter powder (SP) that have been exposed to the laser beam. If a laser is used in step ii), the method of the invention is also referred to as selective laser sintering. Selective laser sintering is known per se to those skilled in the art.

If the radiation source used in the exposing in step ii) is an infrared source, especially a near-infrared source, the wavelength at which the radiation source radiates is typically in the range from 780 nm to 1000 μm, preferably in the range from 780 nm to 50 μm and especially in the range from 780 nm to 2.5 μm.

In the exposing in step ii), in that case, the entire layer of the sinter powder (SP) is typically exposed. In order that only the desired regions of the sinter powder (SP) melt in the exposing, an infrared-absorbing ink (IR-absorbing ink) is typically applied to the regions that are to melt.

The method of producing the shaped body in that case preferably comprises, between step i) and step ii), a step i-1) of applying at least one IR-absorbing ink to at least part of the layer of the sinter powder (SP) provided in step i).

The present invention therefore also further provides a method of producing a shaped body, comprising the steps of:
i) providing a layer of a sinter powder (SP) comprising the following components:
   59.5% to 99.85% by weight, based on the sum total of the percentages by weight of (A), (B), (C), (D) and (E), of at least one thermoplastic polyurethane (A),
   0.05% to 0.5% by weight, based on the sum total of the percentages by weight of (A), (B), (C), (D) and (E), of at least one flow agent (B),
   0.1% to 5% by weight, based on the sum total of the percentages by weight of (A), (B), (C), (D) and (E), of at least one organic additive (C),
   0% to 5% by weight, based on the sum total of the percentages by weight of (A), (B), (C), (D) and (E), of at least one further additive (D) and
   0% to 30% by weight, based on the sum total of the percentages by weight of (A), (B), (C), (D) and (E), of at least one reinforcer (E),
i-1) applying at least one IR-absorbing ink to at least part of the layer of the sinter powder (SP) provided in step i),
ii) exposing the layer of the sinter powder (SP) provided in step i).

Suitable IR-absorbing inks are all IR-absorbing inks known to those skilled in the art, especially IR-absorbing inks known to those skilled in the art for high-speed sintering.

IR-absorbing inks typically comprise at least one absorber that absorbs IR radiation, preferably NIR radiation (near-infrared radiation). In the exposing of the layer of the sinter powder (SP) in step ii), the absorption of the IR radiation, preferably the NIR radiation, by the IR absorber present in the IR-absorbing inks results in selective heating of the part of the layer of the sinter powder (SP) to which the IR-absorbing ink has been applied.

The IR-absorbing ink may, as well as the at least one absorber, comprise a carrier liquid. Suitable carrier liquids are known to those skilled in the art and are, for example, oils or water.

The at least one absorber may be dissolved or dispersed in the carrier liquid.

If the exposure in step ii) is effected with a radiation source selected from infrared sources and if step i-1) is conducted, the method of the invention is also referred to as high-speed sintering (HSS) or multijet fusion (MJF) method. These methods are known per se to those skilled in the art. In the multijet fusion (MJF) method, a non-absorbing ink, a “detailing agent”, is typically also used.

After step ii), the layer of the sinter powder (SP) is typically lowered by the layer thickness of the layer of the sinter powder (SP) provided in step i) and a further layer of the sinter powder (SP) is applied. This is subsequently exposed or heated again in step ii).

This firstly bonds the upper layer of the sinter powder (SP) to the lower layer of the sinter powder (SP); in addition, the particles of the sinter powder (SP) within the upper layer are bonded to one another by fusion.

In the method of the invention, steps i) and ii) and optionally i1) can thus be repeated.

By repeating the lowering of the powder bed, the applying of the sinter powder (SP) and the exposure or heating and hence the melting of the sinter powder (SP), three-dimensional shaped bodies are produced. It is possible to produce shaped bodies that also have cavities, for example. No additional support material is necessary since the unmolten sinter powder (SP) itself acts as a support material.

The present invention therefore also further provides a shaped body obtainable via a sintering method using a sinter powder (SP) of the invention.

The sinter powder (SP) of the invention is of particularly good suitability for use in a sintering method.

The present invention therefore also provides for the use of a sinter powder (SP) comprising the following components:
59.5% to 99.85% by weight, based on the sum total of the percentages by weight of (A), (B), (C), (D) and (E), of at least one thermoplastic polyurethane (A),
0.05% to 0.5% by weight, based on the sum total of the percentages by weight of (A), (B), (C), (D) and (E), of at least one flow agent (B),
0.1% to 5% by weight, based on the sum total of the percentages by weight of (A), (B), (C), (D) and (E), of at least one organic additive (C),
0% to 5% by weight, based on the sum total of the percentages by weight of (A), (B), (C), (D) and (E), of at least one further additive (D) and
0% to 30% by weight, based on the sum total of the percentages by weight of (A), (B), (C), (D) and (E), of at least one reinforcer (E),
in a sintering method, preferably in a selective laser sintering (SLS) method or in a multijet fusion (MJF) method.

However, it is also possible to use the sinter powder (SP) of the invention for production of shaped bodies not only in the selective laser sintering (SLS) method or the multijet fusion (MJF) method but also in other powder-based 3D printing methods.

The present invention further provides for the use of at least one flow agent (B) and at least one organic additive (C) in a sinter powder (SP) comprising at least one thermoplastic polyurethane (A) for improving the flowability and coalescence of the sinter powder (SP).

Shaped Bodies

The method of the invention affords a shaped body. The shaped body can be removed from the powder bed after cooling. Any adhering particles of the sinter powder that have not been melted can be mechanically removed from the surface by known methods. Methods for surface treatment of the shaped body include, for example, vibratory grinding or barrel polishing, and also sandblasting, glass bead blasting or microbead blasting.

It is also possible to subject the shaped bodies obtained to further processing or, for example, to treat the surfaces.

The present invention therefore further provides a shaped body obtainable by the method of the invention.

The resultant shaped body preferably has a tensile strength of ≥5 MPa, more preferably of ≥7 MPa, and more preferably of ≥9 MPa. In addition, it preferably has an elongation at break of ≥100%, more preferably of ≥200%, and especially preferably of ≥300%.

In the context of the present invention, tensile strength and elongation at break are determined with the aid of what is called the tensile test to DIN53504. The test geometry used was the S2 dumbbell specimen, and samples were pulled at 200 mm/min (Z010, Zwick/Roell, Germany). For the measurements, specimens were always taken that were printed in X direction, horizontally in the build space layout.

The resultant shaped bodies typically comprise 59.5% to 99.85% by weight of component (A), 0.05% to 0.5% by weight of component (B), 0.1% to 5% by weight of component (C), 0% to 5% by weight of component (D) and 0% to 30% by weight of component (E), based in each case on the total weight of the shaped body.

The shaped body preferably comprises in the range from 74.15% to 99.7% by weight of component (A), in the range from 0.1% to 0.35% by weight of component (B), in the range from 0.2% to 3% by weight of component (C), in the range from 0% to 2.5% by weight of component (D) and in the range from 0% to 20% by weight of component (E), based in each case on the total weight of the shaped body.

The shaped body most preferably comprises in the range from 76.12% to 99.42% by weight of component (A), in the range from 0.18% to 0.28% by weight of component (B), in the range from 0.4% to 1.1% by weight of component (C), in the range from 0% to 2.5% by weight of component (D) and in the range from 0% to 20% by weight of component (E), based in each case on the total weight of the shaped body.

The percentages by weight of components (A), (B), (C), (D) and (E) typically add up to 100% by weight.

If the shaped body comprises component (D), it may comprise, for example, in the range from 0.1% to 5% by weight of component (D), preferably in the range from 0.2% to 2.5% by weight of component (D), based on the total weight of the shaped body.

If the shaped body comprises component (E), it may comprise, for example, in the range from 5% to 30% by weight of component (E), preferably in the range from 10% to 20% by weight of component (E), based on the total weight of the shaped body.

If the shaped body comprises component (D) and/or component (E), the percentages by weight of the at least one thermoplastic polyurethane (A) present in the shaped body are typically correspondingly reduced, such that the sum total of the percentages by weight of the at least one thermoplastic polyurethane (A), of component (B), of component (C) and of component (D) and/or of component (E) adds up to 100% by weight.

If the shaped body comprises component (D), it thus comprises, for example, in the range from 59.5% to 99.75% by weight of component (A), in the range from 0.05% to 0.5% by weight of component (B), in the range from 0.1% to 5% by weight of component (C), in the range from 0.1% to 5% by weight of component (D) and in the range from 0% to 30% by weight of component (E), based on the total weight of the shaped body.

If the shaped body comprises component (D), it thus preferably comprises in the range from 74.15% to 99.5% by weight of component (A), in the range from 0.1% to 0.35% by weight of component (B), in the range from 0.2% to 3% by weight of component (C), in the range from 0.2% to 2.5% by weight of component (D) and in the range from 0% to 20% by weight of component (E), based on the total weight of the shaped body.

If the shaped body comprises component (D), it thus more preferably comprises in the range from 76.12% to 99.22% by weight of component (A), in the range from 0.18% to 0.28% by weight of component (B), in the range from 0.4% to 1.1% by weight of component (C), in the range from 0.2% to 2.5% by weight of component (D) and in the range from 0% to 20% by weight of component (E), based on the total weight of the shaped body.

If the shaped body comprises component (E), it thus comprises, for example, in the range from 59.5% to 94.85% by weight of component (A), in the range from 0.05% to 0.5% by weight of component (B), in the range from 0.1% to 5% by weight of component (C), in the range from 0% to 5% by weight of component (D) and in the range from 5% to 30% by weight of component (E), based on the total weight of the shaped body.

If the shaped body comprises component (E), it thus preferably comprises in the range from 74.15% to 89.7% by weight of component (A), in the range from 0.1% to 0.35% by weight of component (B), in the range from 0.2% to 3% by weight of component (C), in the range from 0% to 2.5% by weight of component (D) and in the range from 10% to 20% by weight of component (E), based on the total weight of the shaped body.

If the shaped body comprises component (E), it thus more preferably comprises in the range from 76.12% to 89.42% by weight of component (A), in the range from 0.18% to 0.28% by weight of component (B), in the range from 0.4% to 1.1% by weight of component (C), in the range from 0% to 2.5% by weight of component (D) and in the range from 10% to 20% by weight of component (E), based on the total weight of the shaped body.

If the shaped body comprises components (D) and (E), it thus comprises, for example, in the range from 59.5% to 94.75% by weight of component (A), in the range from 0.05% to 0.5% by weight of component (B), in the range from 0.1% to 5% by weight of component (C), in the range from 0.1% to 5% by weight of component (D) and in the range from 5% to 30% by weight of component (E), based on the total weight of the shaped body.

If the shaped body comprises components (D) and (E), it thus preferably comprises in the range from 74.15% to 89.5% by weight of component (A), in the range from 0.1% to 0.35% by weight of component (B), in the range from 0.2% to 3% by weight of component (C), in the range from 0.2% to 2.5% by weight of component (D) and in the range from 10% to 20% by weight of component (E), based on the total weight of the shaped body.

If the shaped body comprises components (D) and (E), it thus more preferably comprises in the range from 76.12% to 89.22% by weight of component (A), in the range from 0.18% to 0.28% by weight of component (B), in the range from 0.4% to 1.1% by weight of component (C), in the range from 0.2% to 2.5% by weight of component (D) and in the range from 10% to 20% by weight of component (E), based on the total weight of the shaped body.

In general, component (A) is the component (A) that was present in the sinter powder (SP). It is likewise the case that component (B) is the component (B) that was present in the sinter powder (SP), component (C) is the component (C) that was present in the sinter powder (SP), component (D) is the component (D) that was present in the sinter powder (SP), and component (E) is the component (E) that was present in the sinter powder (SP).

If step i-1) has been conducted, the shaped body additionally typically comprises residual constituents of the IR-absorbing ink.

It will be clear to the person skilled in the art that, as a result of the exposure or heating of the sinter powder (SP), components (A), (B) and (C) and optionally (D) and (E) can enter into chemical reactions and be altered as a result. Such reactions are known to those skilled in the art.

Preferably, components (A), (B) and (C) and optionally (D) and (E) do not enter into any chemical reaction on exposure in step ii); instead, the sinter powder (SP) merely melts.

The invention is elucidated in detail hereinafter by examples, without restricting it thereto.

### EXAMPLES

The following components are used:
Component (A): thermoplastic polyurethane (TPU); Elastollan SP9415, BASF SE
Component (B1): hydrophobic fumed silica; Aerosil R 812, Evonik, Germany
Component (B2): hydrophobic fumed silica; HDK H20, Wacker Chemie
Component (B3): hydrophobic fumed silica; Aerosil R 972, Evonik, Germany
Component (C): N,N′-ethylenedi(stearamide), dropping point D_{P}=142° C.

Test Methods:

Determination of the Interfacial Energy of the Sinter Powder (SP)

The interfacial energy of the sinter powder (SP) was calculated with the aid of the Owens-Wendt model (Owens, D. K.; Wendt, R. C.; Journal of Applied Polymer Science, 13, 1741, (1969)).

For this purpose, the pulverulent samples were applied to a self-produced adhesive film (Acronal V215 on PET film). Excess material was removed with an air gun. 8 to 10 drops of the test liquids described in table 1 were each applied to the powder layers with a droplet volume of about 1.5 μL. The contact angle θ was determined by droplet contour analysis directly after the first contact with the surface (5 s after the separation of the droplet). The measurement was conducted at 23° C. The analysis unit used was a Drop Shape Analyzer DSA100 (Kruss GmbH, Germany).

FIG. 2 shows the contact angle θ, the interfacial energy of the test liquid γ_{L}, the interfacial energy of the sinter powder (SP) γ_{S} and the interfacial energy γ_{SL} between test liquid and sinter powder (SP). The contact angle is measured by applying the test liquid (I) to the sample (II).

TABLE 1

| | Interfacial energy (mN m⁻¹) | | |
|---|---|---|---|
| | Disperse | Polar | |
| | component | component | Total |
| | (γ_{L}^{D}) | (γ_{L}^{P}) | (γ_{L}) |
| Ethylene glycol | 26.4 | 21.3 | 47.7 |
| Formamide | 39.5 | 18.7 | 58.2 |
| Water | 21.8 | 51.0 | 72.8 |

With the aid of the Owens-Wendt equation (formula IX) and the measured contact angle θ, it is possible by means of linear regression to ascertain the interfacial energy of the powder γ_{S} with the polar component γ_{SP} and the disperse component γ_{SP}:

$$\frac{{γ}_{L} ( 1 + cos θ )}{2 {( {γ}_{L}^{D} )}^{1 / 2}} = {( {γ}_{S}^{P} )}^{1 / 2} \frac{{( {γ}_{L}^{P} )}^{1 / 2}}{{( {γ}_{L}^{D} )}^{1 / 2}} + {( {γ}_{S}^{D} )}^{1 / 2} \qquad ( IX )$$

The following relationships should be noted here (formula X and formula XI):

γ_{L}=γ_{L}^{D}+γ_{L}^{P} (X)

γ_{S}=γ_{S}^{D}+γ_{S}^{P}

Meaning of the Variables:
θ contact angle
γ_{L} interfacial energy of the test liquid
γ_{L}^{D} disperse component of the interfacial energy of the test liquid
γ_{L}^{P} polar component of the interfacial energy of the test liquid
γ_{S} interfacial energy of the sinter powder (SP)
γ_{S}^{D} disperse component of the interfacial energy of the sinter powder (SP)
γ_{S}^{P} polar component of the interfacial energy of the sinter powder (SP)

Determination of the D50 of the Sinter Powder (SP) and the D90 of the at Least One Flow Agent (Component (B))

The particle sizes were determined by means of laser diffraction to ISO 13320 (Horiba LA-960, Retsch Technology, Germany), preceded by dry dispersion of the sinter powder (SP) or the at least one flow agent (B) at 1 bar. The evaluation was effected with the aid of the Fraunhofer method.

Determination of the Dropping Point (Dc) of the at Least One Organic Additive (Component (C))

The dropping point (Dr) of the organic additives was measured to ISO 2176 with a dropping point measuring instrument (AD0566-600, Scavini, Italy).

Determination of the Melting Temperature (T_{M(SP)}) of the Sinter Powder (SP)

The melting temperature was determined by means of DSC (Differential Scanning calorimetry, Discovery series DSC, TA Instruments) to DIN EN ISO 11357.

In the DSC measurements, the sample was subjected under a nitrogen atmosphere to the following temperature cycle: 5 minutes at minus 80° C., then heating to at least 200° C. at 20° C./minute (1st heating run (H1)), then 5 minutes at at least 200° C., then cooling to minus 80° C. at 20° C./minute, then 5 minutes at minus 80° C., then heating to at least 200° C. at 20° C./minute (2nd heating run (H2)). The melting temperature (T_{M(SP)}) then corresponded to the temperature at the maximum of the melting peak of the heating run (H1). If multiple local maxima occur in the range between T_{M}^{onset} and T_{M}^{endset}, the melting temperature T_{M} is understood to mean the numerical average of the respective local maxima.

Determination of the Bulk Density

The bulk density was determined to DIN EN ISO 60.

Determination of the Tensile Strength and Elongation at Break

The determination of the tensile strength and the elongation at break was ascertained with the aid of what is called the tensile test to DIN 53504. The test geometry used was the S2 dumbbell specimen, and the samples were pulled at 200 mm/min (Z010, Zwick/Roell, Germany). For the measurements, specimens were always taken that were printed in X direction, horizontally in the build space layout.

Determination of the Melt Volume Flow Rate of the Sinter Powder (SP) (MVR)

The melt volume flow rate was ascertained to DIN EN ISO 1133 (mi2.1, Gottfert, Germany). For this purpose, the sinter powder (SP) was predried under nitrogen at 110° C. for 2 hours and then analyzed with a load of 2.16 kg and at a temperature=(T_{M(SP)}+40° C.).

### Production of the Sinter Powder (SP)

### Inventive Example 1 (I1)

Component (A) was subjected to heat treatment at 100° C. in a dry nitrogen atmosphere for 48 hours. Subsequently, 0.05% by weight of component (B1) and 1% by weight of component (C) were added, and the mixture was processed mechanically to powder under cryogenic conditions (cryogenic comminution) in a pin mill (GSM 250, Gotic, Germany), and then classified by means of a sieving machine (agitated sieve; 0.1×0.3 mm long meshes). After the grinding, another 0.15% by weight of component (B1) was mixed in (Thermomix TMS, Vorwerk; 5 minutes at 2000 revolutions/minute).

### Inventive Example 2 (I2)

For this example, a composition was produced analogously to example 1. After the grinding, 1% by weight of component (C) was additionally mixed in (N,N′-ethylenedi(stearamide), dropping point 142° C.).

### Comparative Example 3 (CE3)

Example 2 from DE 10 2017 124 047 A1 was reworked.

### Comparative Example 4 (CE4)

For this comparative example, a composition was produced analogously to example 1, except that component (C) was not used. This was done by mixing in 0.55% by weight rather than 0.15% by weight of component (B1) after the grinding.

### Comparative Example 5 (CE5)

For this comparative example, a composition was produced analogously to example 1. This was done by additionally adding 5% by weight of component (C) after the grinding.

### Comparative Example 6 (CE6)

Example 1 from EP 3 157 737 B1 was reworked.

The aforementioned amounts of the components and the properties of the sinter powders (SP) produced are reported in table 2.

TABLE 2

| | Example/comparative example | | | | | |
|---|---|---|---|---|---|---|
| | I1 | I2 | CE3 | CE4 | CE5 | CE6 |
| Component (A) (% by wt.) | 98.8 | 97.8 | 99.8 | 99.4 | 93.8 | — |
| TPU, synthesized to | — | — | — | — | — | 99.8 |
| EP 3 157 737 B1 | | | | | | |
| (% by wt.) | | | | | | |
| Component (B) | 0.2 | 0.2 | 0.2 | 0.6 | 0.2 | 0.2 |
| (=B1 + B2 + B3) | | | | | | |
| (% by wt.) | | | | | | |
| Component (C) | 1.0 | 2.0 | — | — | 6.0 | — |
| (% by wt.) | | | | | | |
| Bulk density (g/L) | 524 | 526 | 500 | 536 | 529 | 490 |
| Contact angle | 134.2 | 135.3 | 126.9 | 121.4 | 137.7 | 125.3 |
| Water (°) | | | | | | |
| Contact angle | 124.6 | 127.1 | 100.6 | 95.9 | 134.3 | 99.5 |
| Ethylene glycol (°) | | | | | | |
| Contact angle | 125.9 | 127.3 | 92.8 | 84.2 | 131.2 | 94.5 |
| Formamide (°) | | | | | | |
| Interfacial energy disperse | 2.6 | 2.5 | 27.7 | 33.6 | 1.0 | 28.6 |
| (mN/m) | | | | | | |
| Interfacial energy polar | 0.2 | 0.2 | 2.1 | 2.0 | 0.4 | 2.0 |
| (mN/m) | | | | | | |
| Interfacial energy total | 2.8 | 2.5 | 29.8 | 35.6 | 1.4 | 31.1 |
| (mN/m) | | | | | | |
| Particle size D50 (μm) | 79 | 77 | 72 | 71 | 74 | 75 |
| Melting point T_{M(SP)} (° C.) | 140 | 140 | 140 | 140 | 140 | 130 |
| Melt volume flow rate MVR | 49 | 53 | 46 | 47 | 54 | 28 |
| (cm³/10 min) | | | | | | |
| Throughput in production | 125 | 125 | 30 | 30 | 125 | 20 |
| (grinding + sieving) (kg/h) | | | | | | |

Production of the Shaped Bodies

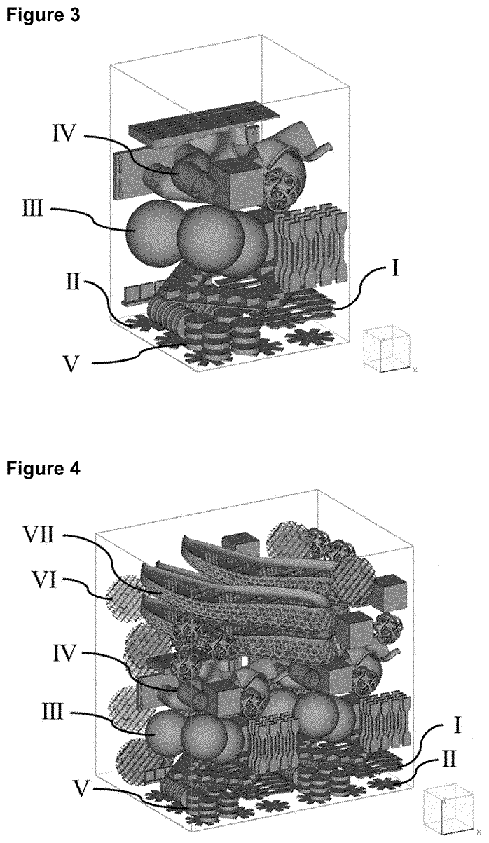

The same build space layout was used in each of the manufacturing examples 1 to 6. The build space layout used is shown in FIG. 3. The following parts were accommodated in the build space layout: 37 tensile bars (I) (X and Z orientation), 9 curl crosses (II) and 41 further technical test pieces such as hollow spheres (III), tubes (IV), sheets (V) and other free-form bodies. The free-form bodies served particularly for verification of component quality. In total, the build space layout has 87 test pieces, dimensions of 180×180×226 mm, and a packing density of 7.7%.

The same build space layout was likewise used in each of the manufacturing examples 10 to 12. This was an adjusted build space layout. This is shown in FIG. 4. The following parts were accommodated in the build space layout: 74 tensile bars (I) (X and Z orientation), 18 curl crosses (II), 120 further technical test pieces such as hollow spheres (III), tubes (IV), sheets (V), grid structures (VI), footwear soles (VII) and other free-form bodies. The free-form bodies served particularly for verification of component quality. In total, the build space layout has 87 test pieces, dimensions of 380×284×371 mm, and a packing density of 7.3%.

### Manufacturing Example 1 (M1I1)

The sinter powder (SP) from inventive example 1 (I1) was processed to shaped bodies by means of a commercial laser sintering machine (Farsoon, HT25IP, China). The processing parameters in the laser sintering operation are given in table 3.

### Manufacturing Example 2 (M1I2)

The sinter powder (SP) from inventive example 2 (I2) was processed to shaped bodies by means of a commercial laser sintering machine (Farsoon, HT251P, China). The processing parameters in the laser sintering operation are given in table 3.

### Manufacturing Example 3 (M1CE3)

The sinter powder (SP) from comparative example 3 (CE3) was processed to shaped bodies by means of a commercial laser sintering machine (Farsoon, HT251P, China). The processing parameters in the laser sintering operation are given in table 3.

### Manufacturing Example 4 (M1CE4)

The sinter powder (SP) from comparative example 4 (CE4) was processed to shaped bodies by means of a commercial laser sintering machine (Farsoon, HT251P, China). The processing parameters in the laser sintering operation are given in table 3.

### Manufacturing Example 5 (M1CE5)

The sinter powder (SP) from comparative example 5 (CE5) was processed to shaped bodies by means of a commercial laser sintering machine (Farsoon, HT251P, China). The processing parameters in the laser sintering operation are given in table 3.

### Manufacturing Example 6 (M1CE6)

The sinter powder (SP) from comparative example 6 (CE6) was processed to shaped bodies by means of a commercial laser sintering machine (Farsoon, HT251P, China). The processing parameters in the laser sintering operation are given in table 3.

TABLE 3

| | Manufacturing examples 1 | Manufacturing |
|---|---|---|
| | to 6 (except 6) | example 6 |
| Laser energy (W) | 50 | 40 |
| Build space | 108 | 95 |
| temperature (° C.) | | |
| Laser line spacing (mm) | 0.10 | 0.2 |
| Laser speed (m/s) | 15 | 4 |
| Powder layer | 0.1 | 0.15 |
| thickness (mm) | | |

### Manufacturing example 10 (M2I1)

The sinter powder (SP) from inventive example 1 (I1) was processed to specimens by means of a multi-jet fusion machine (HP, HP Jet Fusion 5210 3D Printer, USA). The parameter settings used were ‘Ultrasint TPU01—Balanced’.

### Manufacturing Example 11 (M2CE3)

The sinter powder (SP) from comparative example 3 (CE3) was processed to specimens by means of a multi-jet fusion machine (HP, HP Jet Fusion 5210 3D Printer, USA). The parameter settings used were ‘Ultrasint TPU01—Balanced’.

### Manufacturing Example 12 (M2CE5)

The sinter powder (SP) from comparative example 5 (CE5) was processed to specimens by means of a multi-jet fusion machine (HP, HP Jet Fusion 5210 3D Printer, USA). The parameter settings used were ‘Ultrasint TPU01—Balanced’.

Reference 1 (R1)

The values from example 1 of U.S. Pat. No. 8,114,334 B2 were entered as comparative values in table 4.

The properties of the resultant shaped bodies are compiled in tables 4 and 5.

TABLE 4

| | M1 | M1 | M1 | M1 | M1 | M1 | |
|---|---|---|---|---|---|---|---|
| | I1 | I2 | CE3 | CE4 | CE5 | CE6 | R1 |
| Sinter powder | I1 | I2 | CE 3 | CE4 | CE5 | CE6 | — |
| Tensile strength (MPa) | 9.1 | 8.5 | 8.1 | 7.2 | 6.8 | 16 | 2.7 |
| Elongation (%) | 360 | 320 | 270 | 220 | 170 | 370 | 170 |
| Processibility* | 9.7 | 9.3 | 6.3 | 3.3 | 3.8 | 1.2 | — |
| Component quality* | 9.8 | 9.2 | 6.8 | 4.5 | 4.9 | 0.7 | — |
| Build stops** | 0 | 0 | 1 | 2 | 1 | 7 | — |

TABLE 5

| | M2I1 | M2CE3 | M2CE5 |
|---|---|---|---|
| Sinter powder | I1 | CE3 | CE5 |
| Tensile strength (MPa) | 9.0 | 8.3 | 6.3 |
| Elongation (%) | 310 | 280 | 180 |
| Processibility* | 10 | 5.7 | 4.7 |
| Component quality* | 9.9 | 6.4 | 6.1 |
| Build stops** | 0 | 2 | 2 |

*Processibility was monitored by at least three different machine operators during the 10 complete print operations. A complete print operation is understood to mean that the build space layout could be produced in full. Furthermore, the component quality of the shaped bodies that were produced during the aforementioned print operations was examined by the machine operators. Subsequently, processibility and component quality were rated by the machine operators, in each case on a scale from 0 to 10 (10 = best; 1 = worst). The values in tables 5 and 6 correspond to the numerical average of at least three independent assessments. The score of 0 is the lowest assessment. If so many defects were observed during the build that the score would drop below 0, the print operation is stopped (see build stop**). A print attempt is repeated until the build space layout has been produced in full.

The following defects lead to a reduction in the assessment of processibility:
Flowability problems in the dosage/supply of the pulverulent formulation: −2 points
Problems (inhomogeneities) in the application of the powder layers, for example:
   Powder agglomerate formation in/on the powder bed: −1 point
   Streaks in the powder bed: −0.5 point (1-3 streaks), −1 point (4-6 streaks), −2 points (>6 streaks); streaks are understood to mean slight, not very deep grooves.
   Significant holes or grooves in the powder bed: −1 point (per hole or groove)
   Canting/wedging of the application tool (e.g. squeegee, roller): −2 points
   ‘Short feeds’ (in the case of a short feed, too little powder is applied as powder layer): −2 points

The following defects lead to a reduction in the assessment of component quality:
Overmelting of parts owing to significant local buildup of heat in the parts: −1 point
Warpage in manufactured components: −3 points
Surface defects: −1 point (per 3 defects)
Excessively rough surface on the parts: −1 point

** In the case of a build stop, the further print operation is prevented because, for example, the powder application system (blade, roll) becomes blocked, parts have risen up (owing to warpage), parts get stuck on the powder application system and/or the powder dosage is/becomes blocked.

The result of a build stop is that the partly produced moldings have to be discarded and reprinted. This leads to an increase in material loss and an extension of the total build time, which results in an enormous deterioration in economic viability. Therefore, the number of build stops that occurred in the performance of 10 complete build operations (without stoppage) is cited separately. Thus, the number of build stops is not included in the assessment of processibility since a build stop constitutes a manifestly failed process.

1.-14. (canceled)

15. A sinter powder (SP) comprising the following components:
59.5% to 99.85% by weight, based on the sum total of the percentages by weight of (A), (B), (C), (D) and (E), of at least one thermoplastic polyurethane (A),
0.05% to 0.5% by weight, based on the sum total of the percentages by weight of (A), (B), (C), (D) and (E), of at least one flow agent (B),
0.1% to 5% by weight, based on the sum total of the percentages by weight of (A), (B), (C), (D) and (E), of at least one organic additive (C),
0% to 5% by weight, based on the sum total of the percentages by weight of (A), (B), (C), (D) and (E), of at least one further additive (D) and
0% to 30% by weight, based on the sum total of the percentages by weight of (A), (B), (C), (D) and (E), of at least one reinforcer (E), wherein the at least one organic additive (C) is selected from the group consisting of maleic acid-polypropylene waxes, maleic anhydride-grafted polypropylene waxes, and amide waxes.

16. The sinter powder (SP) according to claim 15, wherein the at least one flow agent (B) is selected from the group consisting of silicon dioxide, silicates, silicas, metal oxides, minerals, borates, phosphates, sulfates and carbonates.

17. The sinter powder (SP) according to claim 15, wherein the sinter powder (SP) comprises
i) 74.15% to 99.7% by weight, of component (A), based in each case on the sum total of the percentages by weight of (A), (B), (C), (D) and (E), and/or
ii) 0.1% to 0.35% by weight, of component (B), based in each case on the sum total of the percentages by weight of (A), (B), (C), (D) and (E), and/or
iii) 0.2% to 3% by weight, of component (C), based in each case on the sum total of the percentages by weight of (A), (B), (C), (D) and (E), and/or
iv) 0% to 2.5% by weight of component (D), based on the sum total of the percentages by weight of (A), (B), (C), (D) and (E), and/or
v) 0% to 20% by weight of component (E), based on the sum total of the percentages by weight of components (A), (B), (C), (D) and (E).

18. The sinter powder (SP) according to claim 15, wherein the at least one organic additive (C)
i) is an N,N′-alkylene fatty acid diamide, and/or
ii) is selected in such a way that the dropping point of the at least one organic additive (C) satisfies the following condition (formula I):
(T_{M(A)}−25° C.)≤D_{P}<(T_{M(A)}+25° C.) (I),
where D_{P} is the dropping point of the at least one organic additive (C) and T_{M(A)} is the melting temperature of the at least one thermoplastic polyurethane (A), and/or
iii) is selected such that the total interfacial energy γ_{S} of the sinter powder (SP) is ≤25 mN·m⁻¹, and/or
iv) is selected such that the disperse component of the interfacial energy γ_{S}^{D} of the sinter powder (SP) is ≤20 mN·m⁻¹, and/or
v) is selected such that the polar component of the interfacial energy γ_{S}^{P} of the sinter powder (SP) is ≤5 mN·m⁻¹.

19. The sinter powder (SP) according to claim 15, wherein the sinter powder (SP) has
i) a median particle size (D50) in the range from 10 to 190 μm, and/or
ii) a melting temperature (T_{M(SP)}) in the range from 80 to 220° C., and/or
iii) a melt volume flow rate (MVR) in the range from 3 to 150 cm³/10 min, and/or
iv) a bulk density of ≥300 g/L.

20. The sinter powder (SP) according to claim 15, wherein the at least one flow agent (B) has a D90 of ≤10 μm.

21. The sinter powder (SP) according to claim 15, wherein the at least one further additive (D) is selected from the group consisting of antinucleating agents, stabilizers, conductive additives, end group functionalizers, dyes, antioxidants, flame retardants and color pigments.

22. The sinter powder (SP) according to claim 15, wherein the at least one reinforcer (E) is selected from the group consisting of carbon nanotubes, glass beads and aluminum silicates.

23. A method of producing a sinter powder (SP) comprising
59.5% to 99.85% by weight, based on the total weight of the sinter powder (SP), of at least one thermoplastic polyurethane (A),
0.05% to 0.5% by weight, based on the total weight of the sinter powder (SP), of at least one flow agent (B),
0.1% to 5% by weight, based on the total weight of the sinter powder (SP), of at least one organic additive (C),
0% to 5% by weight, based on the total weight of the sinter powder (SP), of at least one further additive (D) and
0% to 30% by weight, based on the total weight of the sinter powder (SP), of at least one reinforcer (E),
comprising the step of a) grinding the total amount, based on the total weight of the sinter powder (SP), of component (A),
wherein a first portion (BT1) of the total amount, based on the total weight of the sinter powder (SP), of component (B) and/or a first portion (CT1) of the total amount, based on the total weight of the sinter powder (SP), of component (C) are mixed into component (A) prior to step a) to obtain a powder (P), and the remaining portion (BT2) of the total amount of component (B) and/or the remaining portion (CT2) of the total amount of component (C) are mixed into the powder (P) after step a) to obtain the sinter powder (SP), wherein the first portion (BT1) accounts for 0% to 100% by weight of the total amount, based on the total weight of the sinter powder (SP), of component (B) and wherein the first portion (CT1) accounts for 0% to 100% of the total amount, based on the total weight of the sinter powder (SP), of component (C), and wherein the remaining portion (BT2) accounts for (100−BT1)% by weight of the total amount, based on the total weight of the sinter powder (SP), of component (B) and the remaining portion (CT2) accounts for (100−CT1)% by weight of the total amount, based on the total weight of the sinter powder (SP), of component (C),
and wherein optionally
the total amount, based on the total weight of the sinter powder (SP), of component (D) and/or the total amount, based on the total weight of the sinter powder (SP), of component (E) is mixed in before step a) or after step a),
wherein the at least one organic additive (C) is selected from the group consisting of maleic acid- and/or maleic anhydride-grafted polypropylene waxes and amide waxes.

24. A method of producing a shaped body, comprising the steps of:
i) providing a layer of a sinter powder (SP) according to claim 15, and
ii) exposing or heating the layer of the sinter powder (SP) provided in step i).

25. A shaped body obtained by a method according to claim 24.

26. The use of at least one flow agent (B) and at least one organic additive (C) in a sinter powder (SP) comprising at least one thermoplastic polyurethane (A) for improving the flowability and coalescence of the sinter powder (SP), wherein the at least one organic additive (C) is selected from the group consisting of maleic acid- and/or maleic anhydride-grafted polypropylene waxes and amide waxes.

27. A method comprising utilizing the sinter powder (SP) according to claim 15 in a sintering method.

28. A shaped body obtained via a sintering method using the sinter powder (SP) according to claim 15.
